(19) United States
(12) Patent Application Publication
(10) Pub. No.: US 2010/0302644 A1
(43) Pub. Date: Dec. 2, 2010

(54) SLANTED OPTICAL DEVICE

(75) Inventor: Shimon Yalov, Nes Ziona (IL)

Correspondence Address: MARTIN D. MOYNIHAN d/b/a PRTSI, INC., P.O. BOX 16446, ARLINGTON, VA, 22215, US

(73) Assignee: Mirage Innovations Ltd, Petach-Tikva (IL)

(21) Appl. No.: 12/678,805

(22) PCT Filed: Sep. 18, 2008
(86) PCT No.: PCT/IL2008/001256

§ 371 Date: Jul. 19, 2010

Related U.S. Application Data
(60) Provisional application No. 60/960,152, filed on Sep. 18, 2007.

(51) Int. Cl. G02B 27/01

(52) U.S. Cl. 359/630

(57) ABSTRACT

An optical device (300) is disclosed. The optical device (300) comprises a planar substrate (316) formed with an input optical element (310) for receiving and redirecting light for propagation of the light within the substrate (316), and a left and a right output optical element (312, 314) for receiving light propagating within the substrate (316) and coupling the light out of the substrate (316). In an embodiment of the invention, the device comprises a mounting member (330) for mounting the substrate (316) in front of a face of a viewer such that the substrate is slanted at a tilt angle with respect to a line of sight of the viewer and the left and the right output optical elements (312, 314) respectively provide the light to a left eye (25) and a right eye of the viewer.

### FIELD AND BACKGROUND OF THE INVENTION

The present invention, in some embodiments thereof, relates to optics and, more particularly, but not exclusively, to a slanted optical device.

Miniaturization of electronic devices has always been a continuing objective in the field of electronics. Electronic devices are often equipped with some form of a display, which is visible to a user. As these devices reduce in size, there is an increase need for manufacturing compact displays, which are compatible with small size electronic devices. Besides having small dimensions, such displays should not sacrifice image quality, and be available at low cost. By definition the above characteristics are conflicting and many attempts have been made to provide some balanced solution.

An electronic display may provide a real image, the size of which is determined by the physical size of the display device, or a virtual image, the size of which may extend the dimensions of the display device.

A real image is defined as an image, projected on or displayed by a viewing surface positioned at the location of the image, and observed by an unaided human eye (to the extent that the viewer does not require corrective glasses). Examples of real image displays include a cathode ray tube (CRT), a liquid crystal display (LCD), an organic light emitting diode array (OLED), or any screen-projected displays. A real image could be viewed normally from a distance of about at least 25 cm, the minimal distance at which the human eye can utilize focus onto an object. Unless a person is long-sighted, he may not be able to view a sharp image at a closer distance.

By contrast to a real image, a virtual image is defined as an image, which is not projected onto or emitted from a viewing surface, and no light ray connects the image and an observer. A virtual image can only be seen through an optic element, for example a typical virtual image can be obtained from an object placed in front of a converging lens, between the lens and its focal point. Light rays, which are reflected from an individual point on the object, diverge when passing through the lens, thus no two rays share two endpoints. An observer, viewing from the other side of the lens would perceive an image, which is located behind the object, hence enlarged. A virtual image of an object, positioned at the focal plane of a lens, is said to be projected to infinity. A virtual image display system, which includes a miniature display panel and a lens, can enable viewing of a small size, but high content display, from a distance much smaller than 25 cm. Such a display system can provide a viewing capability which is equivalent to a high content, large size real image display system, viewed from much larger distance.

Also known is the use of holographic optical elements in portable virtual image displays. Holographic optical elements serve as an imaging lens and a combiner where a two-dimensional, quasi-monochromatic display is imaged to infinity and reflected into the eye of an observer.

U.S. Pat. No. 4,711,512 to Upatnieks describes a diffractive planar optics head-up display configured to transmit collimated light wavefronts of an image, as well as to allow light rays coming through the aircraft windscreen to pass and be viewed by the pilot. The light wavefronts enter an elongated optical element located within the aircraft cockpit through a first diffractive element, are diffracted into total internal reflection within the optical element, and are diffracted out of the optical element by means of a second diffractive element into the direction of the pilot's eye while retaining the collimation.

U.S. Pat. Nos. 5,966,223 and 5,682,255 to Friesem et al. describe a holographic optical device similar to that of Upatnieks, with the additional aspect that the first diffractive optical element acts further as the collimating element that collimates the waves emitted by each data point in a display source and corrects for field aberrations over the entire field of view.

U.S. Pat. No. 6,757,105 to Niv et al., the contents of which are hereby incorporated by reference, provides a diffractive optical element for optimizing a field of view performance within a multicolor spectrum. The optical element includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the aforementioned diffractive optical element for transmitting light in general and images in particular into the eye of the user.

A binocular device which employs several diffractive optical elements is disclosed in U.S. Published Application Nos. 20060018014 and 20060018019, and in International Patent Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates within the substrate via total internal reflection and coupled out of the optical relay by two output diffractive optical elements. The input and output diffractive optical elements preserve relative angles of the light rays to allow projection of the images with minimal or no distortions. The output elements are spaced apart such that light diffracted by one element is directed to one eye of the viewer and light diffracted by the other element is directed to the other eye of the viewer. The binocular design of these references significantly improves the field of view.

International Patent Publication No. WO2007/031991, the contents of which are hereby incorporated by reference teaches how to select the planar dimensions of the output and input optical elements of a binocular device, such as the device disclosed in U.S. Published Application Nos. 20060018014 and 20060018019 and International Patent Publication No. WO 2006/008734 supra.

International Patent Publication No. WO2007/052265 discloses an optical relay device which is shaped as a structure having an apex section, a right section and a left section being separated from the right section by an air gap (e.g., a V-shape). Two input optical elements located at the apex section redirect light to propagate via total internal reflection in the direction of the left and/or right sections, and two output optical elements located at the left and right sections couple the light out of the relay device.

### SUMMARY OF THE INVENTION

According to an aspect of some embodiments of the present invention there is provided an optical device, comprising: a planar substrate formed with an input optical element for receiving and redirecting light for propagation of the light within the substrate, and a left and a right output optical element for receiving light propagating within the substrate and coupling the light out of the substrate; and a mounting member for mounting the substrate in front of a face of a viewer such that the substrate is slanted at a tilt angle with respect to a line of sight of the viewer and the left and the right output optical elements respectively provide the light to a left eye and a right eye of the viewer.

According to an aspect of some embodiments of the present invention there is provided an optical device, comprising: a planar substrate formed with an input optical element for receiving and redirecting light from an image generating system for propagation of the light within the substrate, and a left and a right output optical element for receiving light propagating within the substrate and coupling the light out of the substrate; and a mounting member for mounting the substrate in front of a face of a viewer such that the substrate is slanted at a tilt angle with respect to an optical axis of the image generating system and the left and the right output optical elements respectively provide a light to a left eye and a right eye of the viewer

According to some embodiments of the invention the substrate is slanted with respect to the optical axis of the image generating system and with respect to a line of sight of the viewer.

According to an aspect of some embodiments of the present invention there is provided a system for generating and transmitting an image, comprising the optical device described herein, and an image generating system for providing the optical device with collimated light constituting the image.

According to an aspect of some embodiments of the present invention there is provided a system for generating and transmitting an image, comprising: an image generating system for generating collimated light constituting the image; and an optical device having a planar substrate formed with an input optical element for receiving and redirecting the collimated light for propagation of the light within the substrate, and a left and a right output optical element for receiving light propagating within the substrate and coupling the light out of the substrate; wherein the substrate is slanted at a tilt angle with respect to an optical axis of the image generating system.

According to some embodiments of the present invention an optical axis of the image generating system is offset from the line of sight with respect to a vertical direction.

According to an aspect of some embodiments of the present invention there is provided a method of viewing an image using the device described herein, comprising transmitting a light beam constituting the image to the input optical element and viewing the image through the output optical elements.

According to an aspect of some embodiments of the present invention there is provided a method of viewing an image, comprising, placing in front of the eyes an optical device having a planar substrate formed with an input optical element for receiving and redirecting light for propagation of the light within the substrate, and a left and a right output optical element for receiving light propagating within the substrate and coupling the light out of the substrate; wherein the an optical device is placed such that the substrate is slanted at a tilt angle with respect to a line of sight and the left and the right output optical elements respectively provide the light to a left eye and a right eye of the viewer; and transmitting a light beam constituting the image to the input optical element, thereby viewing the image.

According to an aspect of some embodiments of the present invention there is provided a method of designing an optical relay device having a planar substrate formed with an input optical element and a left and a right output optical elements, the method comprising: (a) inputting a tilt angle of the substrate with respect to an optical axis, an angular field of view, eye box dimensions and an eye relief distance; (b) calculating dimensions and relative positions of the optical elements based on the input; (c) calculating a calculated eye relief distance; and (d) iteratively repeating (b)-(c) based on a comparison between the calculated eye relief distance and the inputted eye relief distance.

According to some embodiments of the present invention a lowest edge of the input optical element is offset with respect to a straight line connecting lowest edges of the output optical elements.

According to some embodiments of the invention the offset is optimized to ensure light propagation from a corner of the input optical element to a closest corner of the output optical elements.

According to some embodiments of the invention the offset is approximately (IPD−W_{I}−W_{O})tg φ/2, wherein: IPD is the distance between centers of the output optical elements, W_{I} is a width of the input optical element, W_{O} is a width of the output optical elements, and φ is an angle of the light propagation between the closest corners relative to a direction defined by the centers of the output optical elements.

According to some embodiments of the present invention the input and the output optical elements are linear diffraction gratings.

According to some embodiments of the invention the offset is optimized to ensure light propagation between from a corner of the input optical element to a closest corner of the output optical elements.

According to some embodiments of the invention the offset is approximately (IPD−W_{I}−W_{O})D sin(θ−ω)/(2λ), wherein: IPD is the distance between the centers of the output optical elements, W_{I} is a width of the input optical element, W_{O} is a width of the output optical elements, D is the grating period, θ is the tilt angle, ω is half a vertical field of view of the device and λ is a wavelength of the light.

According to some embodiments of the present invention the light is polychromatic light having a spectrum of wavelengths and wherein the offset is approximately (IPD−W_{I}−W_{O})D sin(θ−ω)/(2λ_{R}), wherein: IPD is the distance between the centers of the output optical elements, W_{I} is a width of the input optical element, W_{O} is a width of the output optical elements, D is the grating period, θ is the tilt angle, ω is half a vertical field of view of the device and λ_{R} is a longest wavelength of the spectrum.

According to some embodiments of the present invention the substrate comprises a recess for receiving a nose of the viewer.

According to some embodiments of the invention the tilt angle is selected so as to reduce an eye relief distance by at least 10%.

According to some embodiments of the present invention the device is characterized by a horizontal field of view of at least 15 degrees, and is capable of providing the field of view to a viewer having any interpupillary distance from about 40 millimeters to about 80 millimeters.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of light diffraction by a linear diffraction grating;

FIG. 2 is a schematic illustration of a binocular system in an upright configuration;

FIGS. 3A-B are schematic illustrations of a binocular optical device in a slanted configuration;

FIG. 4 is a schematic illustration of the binocular optical device of FIG. 3A from viewpoint A;

FIGS. 5A-B are schematic illustrations demonstrating reduction of eye relief;

FIG. 6 is a flowchart diagram describing a method suitable for designing an optical relay device;

FIG. 7 shows result of iterations performed according to some embodiments of the present invention to design an optical relay device;

FIG. 8 is a schematic illustration of an optical system which incorporates a device in a slanted configuration; and

FIGS. 9A-C illustrate an optical system which incorporates a device in a slanted configuration in an embodiment in which the device is worn as spectacles.

### DESCRIPTION OF SPECIFIC EMBODIMENTS OF THE INVENTION

The present invention, in some embodiments thereof, relates to optics and, more particularly, but not exclusively, to a slanted optical device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

When a ray of light propagating within a light-transmissive substrate and striking one of its internal surfaces at an angle φ₁ as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin φ₂=n_{S} sin φ₁, (EQ. 1)

where n_{S} is the index of refraction of the light-transmissive substrate, n_{A} is the index of refraction of the medium outside the light transmissive substrate (n_{S}>n_{A}), and φ₂ is the angle in which the ray is refracted out, in case of refraction. Similarly to φ₁, φ₂ is measured from a normal to the surface. A typical medium outside the light transmissive substrate is air having an index of refraction of about unity.

As a general rule, the index of refraction of any substrate depends on the specific wavelength λ of the light which strikes its surface. Given the impact angle, φ₁, and the refraction indices, n_{S} and n_{A}, Equation 1 has a solution for φ₂ only for φ₁ which is smaller than arcsine of n_{A}/n_{S} often called the critical angle and denoted α_{c}. Hence, for sufficiently large φ₁ (above the critical angle), no refraction angle φ₂ satisfies Equation 1 and light energy is trapped within the light-transmissive substrate. In other words, the light is reflected from the internal surface as if it had stroked a mirror. Under these conditions, total internal reflection is said to take place. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

In planar optics one of the methods to couple light in and out of the substrate is with the aid of diffraction gratings. Such diffraction elements are typically manufactured by holographic or lithographic means. Diffraction gratings can operate in transmission mode, in which case the light experiences diffraction by passing through the gratings, or in reflection mode in which case the light experiences diffraction while being reflected off the gratings

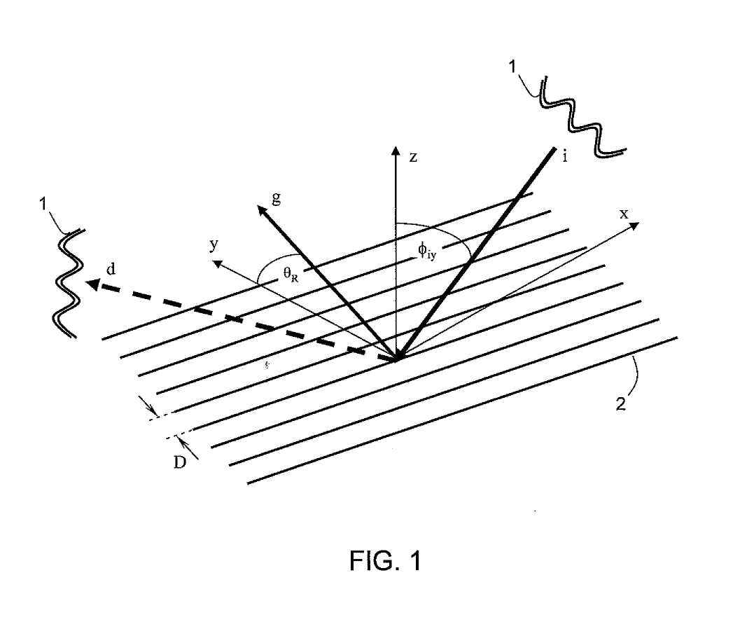

FIG. 1 schematically illustrates diffraction of light by a linear diffraction grating operating in transmission mode. One of ordinary skills in the art, provided with the details described herein would know how to adjust the description for the case of reflection mode.

A wavefront 1 of the light propagates along a vector i and impinges upon a grating 2 engaging the x-y plane. The normal to the grating is therefore along the z direction and the angle of incidence of the light φᵢ is conveniently measured between the vector i and the z axis. In the description below, φᵢ is decomposed into two angles, φᵢₓ and φ_{iy}, where φᵢₓ is the incidence angle in the z-x plane, and φ_{iy} is the incidence angle in the z-y plane. For clarity of presentation, only φ_{iy} is illustrated in FIG. 1.

The grating has a periodic linear structure along a vector g, forming an angle θ_{R} with the y axis. The period of the grating (also known as the grating pitch) is denoted by D. The grating is formed on a light transmissive substrate having an index of refraction denoted by n_{S}.

Following diffraction by grating 2, wavefront 1 changes its direction of propagation. The principal diffraction direction which corresponds to the first order of diffraction is denoted by d and illustrated as a dashed vector in FIG. 1. Similarly to the angle of incidence, the angle of diffraction φ_{d}, is measured between the vector d and the z axis, and is decomposed into two angles, φ_{dx} and φ_{dy}, where φ_{dx} is the diffraction angle in the z-x plane, and φ_{dy} is the diffraction angle in the z-y plane.

The relation between the grating vector g, the diffraction vector d and the incident vector i can therefore be expressed in terms of five angles (θ_{R}, φᵢₓ, φ_{iy}, φ_{dx} and φ_{dy}) and it generally depends on the wavelength λ of the light and the grating period D through the following pair of equations:

sin(φᵢₓ)−n_{S} sin(φ_{dx})=(λ/D)sin(θ_{R}) (EQ. 2)

sin(φ_{iy})+n_{S} sin(φ_{dy})=(λ/D)cos(θ_{R}). (EQ. 3)

Without the loss of generality, the Cartesian coordinate system can be selected such that the vector i lies in the y-z plane, hence sin(φᵢₓ)=0. In the special case in which the vector g lies along the y axis, θ_{R}=0° or 180°, and Equations 2-3 reduce to the following one-dimensional grating equation:

sin φ_{iy}+n_{S} sin φ_{dy}=±λ/D. (EQ. 4)

According the known conventions, the sign of φᵢₓ, φ_{iy}, φ_{dx} and φ_{dy} is positive, if the angles are measured clockwise from the normal to the grating, and negative otherwise. The dual sign on the RHS of the one-dimensional grating equation relates to two possible orders of diffraction, +1 and −1, corresponding to diffractions in opposite directions, say, “diffraction to the right” and “diffraction to the left,” respectively. Generally, there can also other orders of diffractions (namely other than ±1) and a more general form of Equation 4 reads:

sin φ_{iy}+n_{S} sin φ_{dy}=m λ/D, (EQ. 5)

where m is an integer (m=0, ±1, ±2, . . . ) denoting the diffraction order. The special case for which m=0, is known in the literature as the zero diffraction order, and is sometimes referred to as the non-diffraction case. A light ray, entering a substrate through a grating, impinge on the internal surface of the substrate opposite to the grating at an angle which depends on the two diffraction components sin(φ_{dx}) and sin(φ_{dy}) according to the following equation:

φ_{d}=sin⁻¹ {[sin²(φ_{dx})+sin²(φ_{dy})]^{1/2}} (EQ. 6)

When φ_{d} is larger than the critical angle α_{c}, the wavefront undergoes total internal reflection and begin to propagate within the substrate.

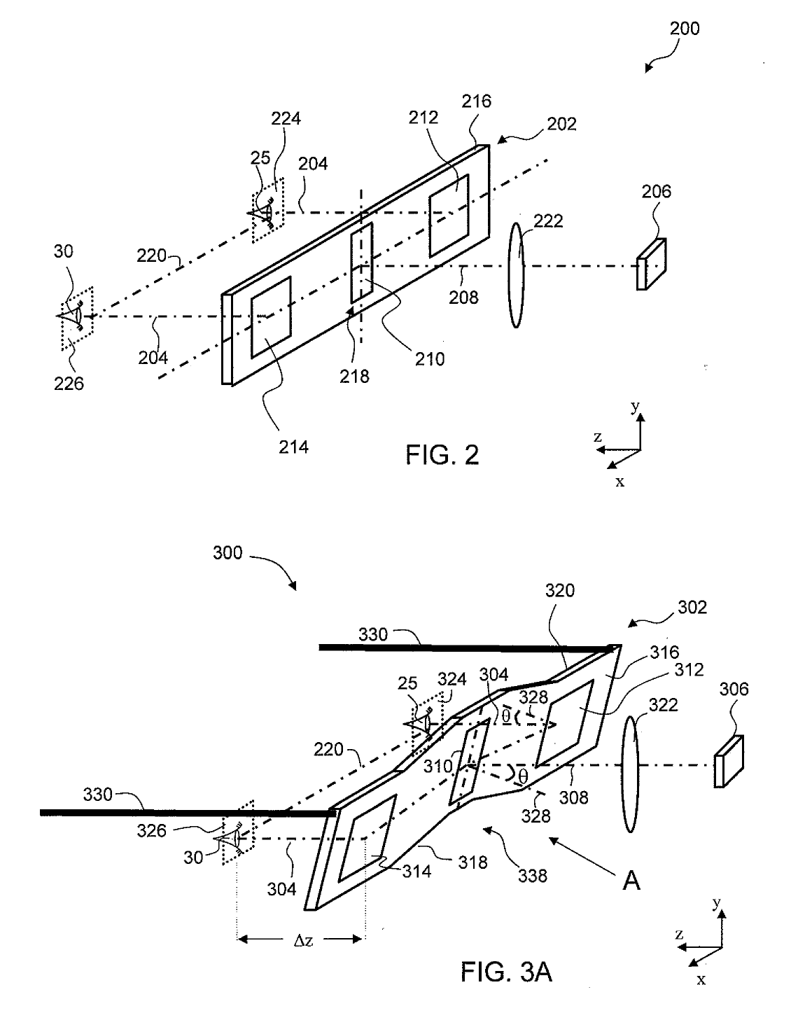

For purposes of better understanding some embodiments of the present invention, reference is first made to the construction and operation of a binocular system 200 as illustrated in FIG. 2.

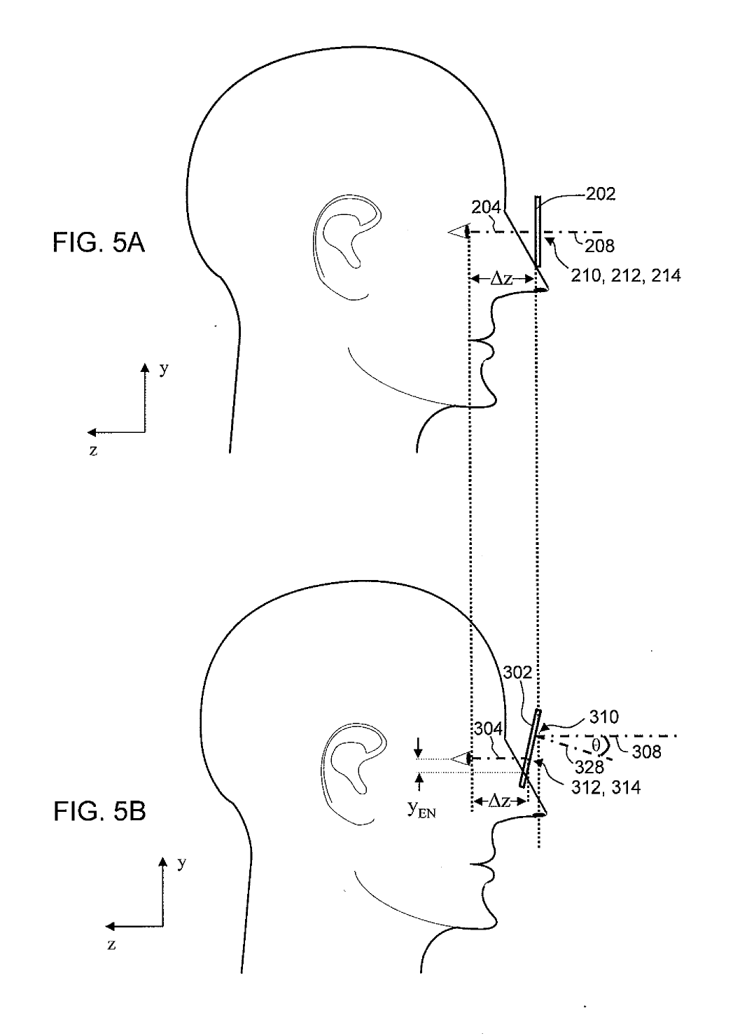

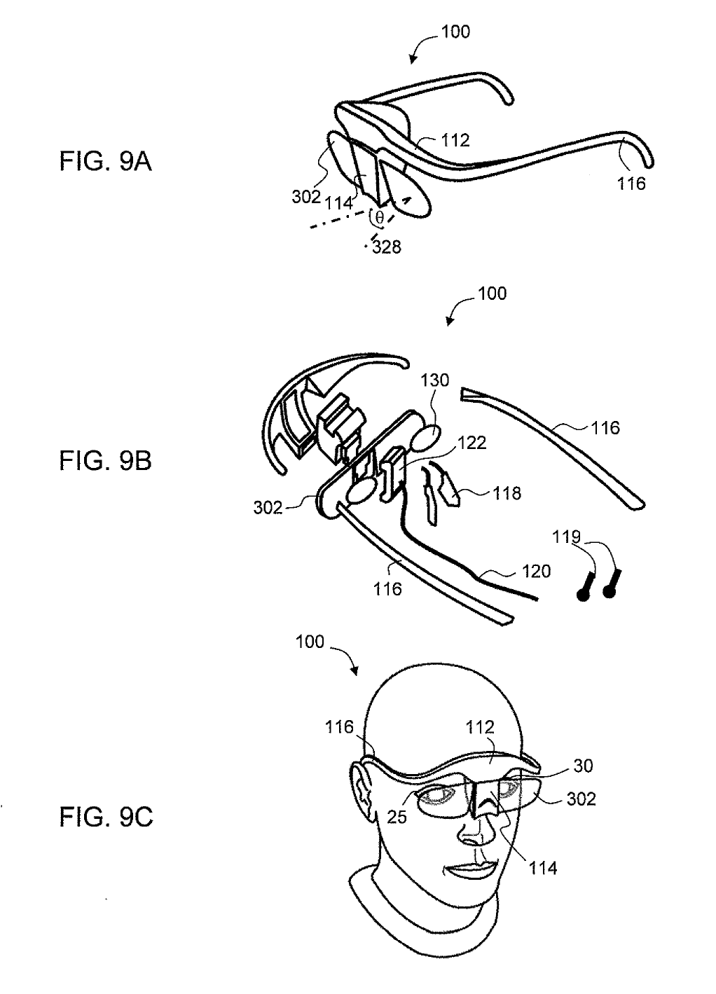

Binocular system 200 comprises an optical relay device 202 mounted in front of the eyes 25 and 30 of a user (the user is not shown in FIG. 2, see FIGS. 5A, 5B and 9C) at a substantially vertical orientation (approximately perpendicular to the line of sight 204 of the user), and an image generating system 206 which generates a light beam constituting an image. Optical relay device 202 comprises an input optical element 210 and two output optical elements 212 and 214 formed in a light transmissive substrate 216.

The generated image is collimated by the lens 222 and arrives at element 210. Lens 222 projects the image constituted by the light to infinity (the equivalent term “focuses the image at infinity” is also used in the literature). Element 210 redirects the incoming light into substrate 216 in a manner such that different portions of the light propagate in different directions within substrate 216. Element 210 redirects some light rays to propagate within substrate 216 and subsequently impinge on output element 212, and some light rays to propagate within substrate 216 and subsequently impinge on element 214. Elements 212 and 214 redirect the respective light rays out of substrate 216. It should be noted that each point of image generating system 206 emits light in a wide range of angles, which are then collected by lens 222 and are transformed into light rays propagating parallel to the line connecting the light emitting point and the lens front nodal point. All these light rays are represented in FIG. 2 by a light ray emitted from the center of image generating system 206 along the principal direction (coincides with line 208). One of ordinary skill in the art of geometrical optics would know how to adjust the schematic illustration of FIG. 2 to show light rays in other directions.

FIG. 2 also illustrates a Cartesian coordinate system oriented such the line of sight 204 is parallel to the z direction, and the line 220 connecting the pupils of the left eye 25 and right eye 30 is parallel to the x direction. The y direction is orthogonal to both x and z directions. As shown, optical relay device 202 lies in the x-y plane and the optical axis 208 of lens 222 is along the z direction.

For each output element, there is a two-dimensional region 224, 226 at which the user can place eye 25, 30 respectively, so as to receive a sufficient amount of the outgoing unaberrated light rays to allow him or her to perceive an image of sufficient quality. This two-dimensional region is referred to in the literature (see, e.g., U.S. Pat. No. 6,833,955 and International Patent Publication No. WO2007/031991 both assigned to the same assignee as the present application and being incorporated by reference by their entirety) as an “eye-box” of the relay device. The distance between the eye-box and the respective output element is referred to in the literature as the “eye relief.” Specifically, the eye relief is the distance between eye-box 224 and element 212 or the distance between eye-box 226 and element 214.

Optical relay device 202 is thus mounted such that left eye 25 is placed within eye-box 224 associated with element 212 and right eye 30 is placed within the eye-box 226 associated with element 214 to allow the user viewing the image.

The dimensions associated with system 200, such as the sizes of the various optical elements of the relay device and the image generating system, the physical distances between the relay device and the eyes and/or the image generating system and the lateral separation between the output elements are interrelated. International Patent Publication No. WO2007/031991 supra teaches the mathematical relations between the dimensions of the optical elements of the relay device, the eye relief distance and the size of the eye box.

It was found by the inventor of the present invention that it would be advantageous to reduce the eye relief associated with the optical relay device because such reduction can facilitate easier optical design. For example, shorter eye-relief allows reduction of the sizes of at least one of the input optical element, the output optical element and the lens. It was also found by the present inventor that when the optical relay device is perpendicular to the line of sight, it is difficult to reduce the eye relief. The eye relief distance is minimal when the bottom edge 218 of input element 210 touches the nose of the user, and further reduction of the distance is not possible (see, for example, FIG. 5A, where Δz denotes the eye relief).

The present inventor has devised a configuration in which the optical relay device is slanted. It has been conceived by the present inventor that such configuration can reduce the eye-relief associated with the optical relay device.

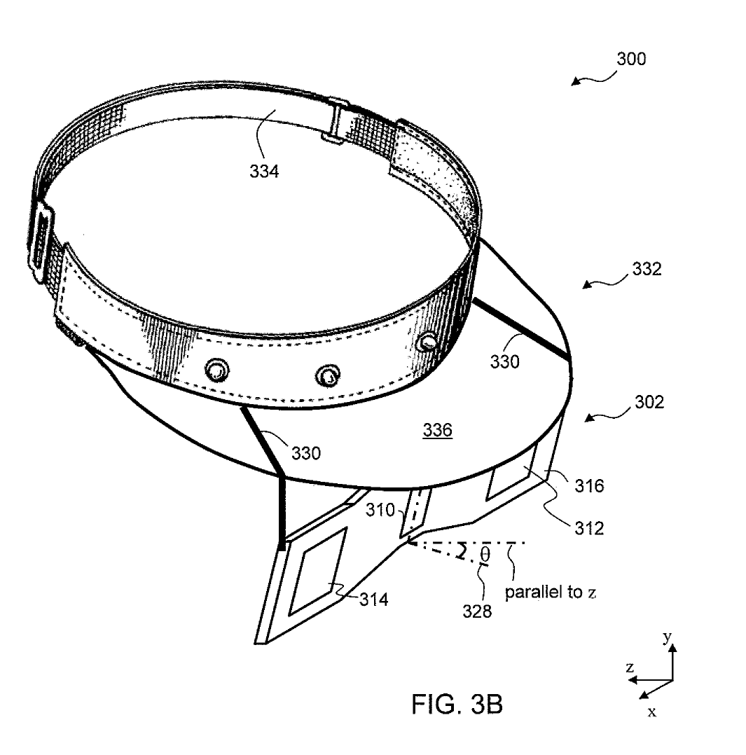

Reference is now made to FIGS. 3A-B which are schematic illustrations of an optical device 300, according to various exemplary embodiments of the present invention. Device 300 comprises an optical relay device 302 having a planar substrate 316 formed with an input optical element 310 for receiving light from an image generation system 306 and redirecting the light for propagation within substrate 316, and a left 312 and a right 314 output optical elements for receiving light propagating within substrate 316 and coupling the light out of substrate 316.

In various exemplary embodiments of the invention device 300 further comprises a mounting member 330 for mounting substrate 316 in front of a face of a viewer (not shown). In some embodiments, there is a recess 338 in substrate 316, e.g., for receiving a nose of the viewer while substrate 316 is mounted in front of the viewer's face. For example, substrate 316 can be shaped as a chevron, a crescent or any one of the known open plane figures with an air gap, which are traditionally referred to as V-shapes, U-shapes, C-shapes, Ω-shapes and the like.

Mounting member 330 preferably mounts substrate 316 such that substrate 316 is slanted at a tilt angle θ with respect to the line of sight 304 of the viewer, and output optical elements 312 and 314 provide light to left eye 25 and right eye 30 of the viewer, respectively. Tilt angle θ can be defined as the acute angle between the line of sight 304 and the normal 328 to substrate 316. The eye-boxes associated with elements 312 and 314 are generally shown at 324 and 326 respectively.

The line of sight is defined as a straight line passing through an eye pupil and a center of an output element in front of the pupil. Specifically, the line of sight connects the pupil of left eye 25 with the center of element 312 or the pupil of right eye 30 with the center of element 314.

FIGS. 3A-B also illustrate the Cartesian coordinate system x-y-z which is oriented similarly to the coordinate system illustrated in FIG. 2 namely the line of sight 304 is parallel to the z direction, and the line 220 connecting the pupils of the left eye 25 and right eye 30 is parallel to the x direction. The y direction is perpendicular to line of sight 304 as well as line 220 (and consequently to both x and z directions) and referred to herein as “the vertical direction”. The geometrical distance between the centers of elements 312 and 314 corresponds to the typical interpupillary distance of the viewer and is referred to as IPD.

As shown in FIGS. 3A-B, substrate 316 is not parallel to the x-y plane, but is rather slanted such that its lower edge 318 is closer to the face of the viewer than its upper edge 320. Mathematically, substrate 316 is slanted at a tilt angle θ measured between the z axis and the normal 328 to substrate 316. In various exemplary embodiments of the invention θ is at least 10°, more preferably at least 15°, more preferably at least 20°, say about 25° or more. Since substrate 316 is slanted, the eye-relief Δz of optical relay device 302 is defined as the distance along the z direction between the center of eye box 326 and element 314 or between the center of eye box 324 and element 312.

Mounting member 330 is shown in FIG. 3A as rearward extending arms adapted to engage the viewer's temples or ears, but this need not necessarily be the case, since, for some applications, it may not be necessary to mount device 302 by engaging the ears or temples. For example, in some embodiments of the present invention mounting member 330 is attachable to a headgear 332 (e.g., a hat, a hamlet, a headband, a visor, a facial mask, a nose mask or the like) such that when the headgear is worn by the viewer substrate 316 is slanted at the tilt angle with respect to the line of sight, and output optical elements 312 and 314 provide light to the eyes. Elements 312 and 314 can be diffractive optical elements, in which case they diffract the light to the eyes, as further detailed hereinunder. A representative configuration in which headgear 332 includes a headband 334 and a visor 336 is illustrated in FIG. 3B. Some of the features shown in FIG. 3A have been omitted from FIG. 3B, for clarity of presentation.

The light impinging at the input optical element of device 302 is preferably collimated. In case the light is not collimated, a collimating system 322 can be positioned on the light path before it impinges input element 310. Collimating system 322 can be, for example, a refractive system, such as, but not limited to, a positive lens (spherical or aspherical) or an arrangement of lenses having an optical axis 308. Collimating system 322 is preferably aligned such that its optical axis is substantially parallel to line of sight 304. Thus, substrate 316 is slanted at a tilt angle θ with respect to the optical axis 308 of collimating system 322. As shown in FIGS. 3A-B, tilt angle θ can be defined as the acute angle measured between the normal 328 to substrate 316 and optical axis 308.

Collimating system 322 can also be a diffractive optical element, which may be spaced apart, carried by or formed in substrate 316. A diffractive collimating system may be positioned either on the entry surface of substrate 316, as a transmissive diffractive element or on the opposite surface as a reflective diffractive element.

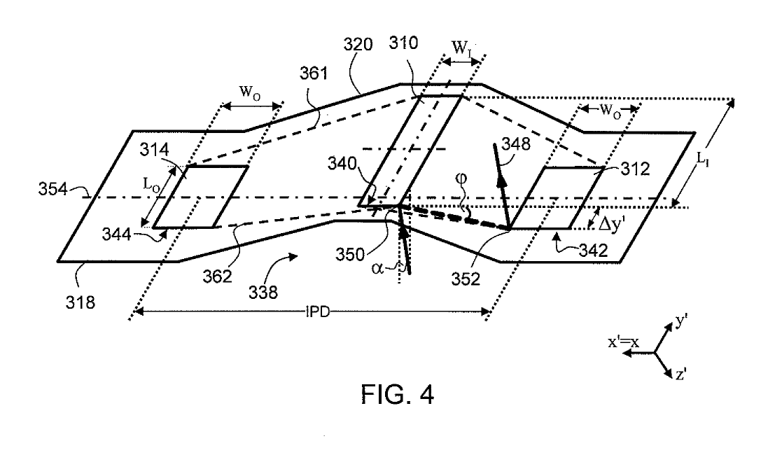

In various exemplary embodiments of the invention the lowest edge of input optical element 310 is offset with respect to a straight line connecting the lowest edges of output optical elements 312 and 314. As will be described in details hereinunder, this embodiment corresponds to a configuration in which in the y-z plane the optical axis 308 of collimating system 322 is offset from the line of sight 304 with respect to the vertical direction (the y direction in the present coordinate system). This embodiment is better seen in FIG. 4, which schematically illustrates device 302 from viewpoint A of FIG. 3A. Shown in FIG. 4 is a Cartesian coordinate system x′-y′-z′ which is the result of a rotation of the x-y-z system at an angle θ around the x axis defined by a straight line connecting the centers of elements 312 and 314. Thus, the relation between the x-y-z and x-y′-z′ coordinate systems is: x′=x, y′=y cos θ−z sin θ, and z′=y sin θ+z cos θ.

Also shown in FIG. 4 is a light ray 348 which is redirected by input element 310 to propagate within substrate 316 in the direction of output element 312 which couples ray 348 out of the substrate. The optical path of ray 348 within substrate 316 passes through a corner 350 on the lowest edge 340 of input element 310 and a corner 352 on a lowest edge 342 of output element 312. Corner 350 is the closest corner of element 310 to corner 352. The ordinarily skilled person will appreciate that there are many other light rays which traverse other optical paths within substrate 316.

Substrate 316 is perpendicular to the z′ axis, namely that the all points on the surface of substrate 316 have the same z′ coordinate. The lowest edges 342 and 344 of output elements 312 and 314 respectively are aligned with respect to the y′ axis (i.e., they have the same y′ coordinate) but the lowest edge 340 of input element 310 is not aligned with centers 342 and 344 with respect to the y′ axis. The offset Δy′ of edge 340 is defined as the difference between the y′ coordinate of edge 340 and the y′ coordinate of edges 342 and 344. In various exemplary embodiments of the invention offset Δy′ is optimized to ensure light propagation from corner 350 to corner 352. For example, Δy′ can be calculated according to the following formula:

$$Δ {y}^{′} = \frac{( IPD - {w}_{I} - {w}_{O} )}{2} tg ϕ \qquad ( EQ . 7 )$$

where φ is the angle of the geometrical line connecting corners 350 and 352 with respect to the x direction, IPD is the distance between the centers of output elements 312 and 314 (corresponding to a typical interpupillary distance of the viewer), and W_{I} and W_{O} are, respectively, the widths of input element 310 and output element 312 along the y′ direction.

In the embodiments in which the input element is offset, slanting of substrate 316 at tilt angle θ can facilitate reduction of the eye relief because the output elements can be advanced in the direction of the eyes while the input element position is not limited by nose. In this embodiment recess 338 is particularly useful since the parts of substrate 316 which are below the nose line of the viewer can be further advanced towards the eyes.

The reduction of the eye relief is illustrated in FIGS. 5A-B.

FIG. 5A illustrates a configuration in which the optical relay device (e.g., relay device 202) is in an upright orientation (perpendicular to the z direction, in the present coordinate system). Input 210 and output 212, 214 elements are not shown in FIG. 5A but the location of their centers in the y-z plane is indicated by an arrow. In this configuration, the optical axis 208 and the line of sight 204 are co-aligned with respect to the y axis.

FIG. 5B illustrates a configuration according to various exemplary embodiments of the present invention in which optical relay device 302 is slanted at a tilt angle θ defined as the acute angle between optical axis 308 and the normal 328 to surface 316. Input 310 and output 312, 314 elements are not shown in FIG. 5B but the location of their centers are indicated by arrows. In this configuration, the optical axis 308 is not co-aligned with line of sight 304 with respect to the y axis. Rather, axis 308 is parallel but offset from line of sight 304, with respect to the vertical direction (the y direction in the present coordinate system).

Two vertical dotted lines are drawn between FIG. 5A and FIG. 5B to illustrate the difference in eye reliefs between the two configurations. In the slanted configuration (FIG. 5B), the eye relief is shorter compared to the upright configuration (FIG. 5A). In some embodiments of the present invention tilt angle θ is selected so as to reduce the eye relief distance by at least 10%, more preferably at least 15%, e.g., about 20%.

An additional advantage of the slanted configuration over the upright configuration is that it allows the use of a single input element even in the case in which the lowest edge of the input element is offset with respect to the lowest edges of the output elements (namely Δy′≠0). This is an advantage over the configuration disclosed in International Publication No. WO 2007/052265, in which two input elements separated by an optical absorber are employed.

Device 302 is preferably designed to transmit light striking substrate 316 at any angle of incidence within a predetermined range of angles, which predetermined range of angles is referred to as the field of view of the device.

The input optical element of device 302 is designed to trap all light rays in the field of view within the substrate. A field of view can be expressed either inclusively, in which case its value corresponds to the difference between the minimal and maximal incident angles, or explicitly in which case the field of view has a form of a mathematical range or set. Thus, for example, a field of view, Ω, spanning from a minimal incident angle, α, to a maximal incident angle, β, is expressed inclusively as Ω=β−α, and exclusively as Ω=[α, β]. The minimal and maximal incident angles are also referred to as rightmost and leftmost incident angles or counterclockwise and clockwise field of view angles, in any combination. The inclusive and exclusive representations of the field of view are used herein interchangeably.

Below, the terms “vertical field of view” and “horizontal field of view” will be used to describe the angular range within the field of view as projected on the x-z and y-z planes respectively.

In various exemplary embodiments of the invention, the optical elements of the optical relay device are designed to transmit an image covering a wide field of view to both eyes of the user. Preferably, the optical relay device of the present embodiments is characterized by a field of view of at least 16° (corresponding to horizontal field of view of about 12°), more preferably at least 20° (corresponding to horizontal field of view of about 15°), more preferably at least 24° (corresponding to horizontal field of view of about 18°), more preferably at least 32° (corresponding to horizontal field of view of about 24°). The optical elements are preferably located at fixed locations on the substrate, but provide the image for any interpupillary distance from a minimal value denoted IPDₘᵢₙ to a maximal value denoted IPDₘₐₓ.

The advantage of the present embodiments is that any user with an interpupillary distance IPD satisfying IPDₘᵢₙ≦IPD≦IPDₘₐₓ can use the device to view the entire image without having to adjust the size of the device or the separation between the optical elements. The range of IPD in western society grown-ups is from about 53 mm to about 73 mm. Children have further smaller IPD. Other human races generally have different ranges of IPD. A preferred value for IPDₘᵢₙ is from about 5 mm to about 20 millimeters less than the selected value for IPDₘₐₓ, more preferably from about 5 mm to about 10 millimeters less than the selected value for IPDₘₐₓ, and the two values are preferably selected within the range of human IPD as described above.

Each of the optical elements can be a refractive element, a reflective element or a diffractive element. In embodiments in which a refractive element is employed, elements 310, 312 and/or 314 can comprise a plurality of linearly stretched mini- or micro-prisms, and the redirection of light is generally by the refraction phenomenon described by Snell's law. Thus, for example, when the elements are refractive, the input element refracts the light into the substrate such that at least a few light rays experience total internal reflection and propagate within the substrate, and the output element refracts at least a few of the propagating light rays out of the substrate. Refractive elements in the form of mini- or micro-prisms are known in the art and are found, e.g., in U.S. Pat. Nos. 5,969,869, 6,941,069 and 6,687,010, the contents of which are hereby incorporated by reference.

In embodiments in which a reflective element is employed, any of the input and/or output optical elements can comprise a plurality of dielectric minors, and the redirection of light is generally by the reflection phenomenon, described by the basic law of reflection. Thus, for example, when the elements are reflective elements, the input element reflects the light into the substrate such that at least a few light rays experience total internal reflection and propagate within the substrate, and the output element reflects at least a few of the propagating light rays out of the substrate. Reflective elements in the form of dielectric mirrors are known in the art and are found, e.g., in U.S. Pat. Nos. 6,330,388 and 6,766,082, the contents of which are hereby incorporated by reference.

The input and output elements can also combine reflection with refraction. For example, the input and/or output optical elements can comprise a plurality of partially reflecting surfaces located in the substrate. In this embodiment, the partially reflecting surfaces are preferably parallel to each other. Optical elements of this type are known in the art and found, e.g., in U.S. Pat. No. 6,829,095, the contents of which are hereby incorporated by reference.

In embodiments in which diffractive element is employed, the input and/or output elements can comprise a grating and the redirection of light is generally by the diffraction phenomenon. Thus, for example, when the elements are diffractive elements, the input element diffracts the light into the substrate such that at least a few light rays experience total internal reflection and propagate within the substrate, and the output element diffracts at least a few of the propagating light rays out of the substrate.

The term “diffracting” as used herein, refers to a change in the propagation direction of a wavefront, in either a transmission mode or a reflection mode. In a transmission mode, “diffracting” refers to change in the propagation direction of a wavefront while passing through the diffractive element; in a reflection mode, “diffracting” refers to change in the propagation direction of a wavefront while reflecting off the diffractive element in an angle different from the specular reflection angle (which is identical to the angle of incidence).

The input element is designed and constructed such that the angle of at least a few of the light rays redirected thereby is above the critical angle, to enable propagation of the light in the substrate via total internal reflection. The propagated light, after a few reflections within the substrate, reaches one of the output elements which redirects the light out of substrate.

According to a preferred embodiment of the present invention at least one of the input and/or output optical elements comprises a linear diffraction grating, operating according to the principles described above. When all elements are linear gratings, their periodic linear structures are preferably substantially parallel.

The optical elements can be formed on or attached to any of the surfaces of the substrate. One ordinarily skilled in the art would appreciate that this corresponds to any combination of transmissive and reflective optical elements. Thus, for example, suppose that the input optical element is formed on a first surface of the substrate and the output optical elements are formed on an opposite surface of the substrate. Suppose further that the light is incident on the first surface and it is desired to diffract the light out of the opposite surface. In this case, the optical elements are all transmissive, so as to ensure that entrance of the light through the input optical element, and the exit of the light through the output optical elements. Alternatively, if the input and output optical elements are all formed on a first surface of the substrate, then the input optical element remain transmissive, so as to ensure the entrance of the light therethrough, while the output optical elements are reflective, so as to diffract the propagating light out by reflection at an angle which is sufficiently small to couple the light out. In such configuration, light can enter the substrate through the side opposite the input optical element, be diffracted in reflection mode by the input optical elements, propagate within the light transmissive substrate in total internal diffraction and be diffracted out by the output optical elements operating in a transmission mode.

When the optical elements 310, 312 and 314 are linear diffraction gratings, EQ. 7 can be written as:

$$Δ {y}^{′} = \frac{( IPD - {w}_{I} - {w}_{O} ) D}{2 λ} sin ( θ - {ω}_{y} ) \qquad ( EQ . 8 )$$

where IPD, W_{I}, W_{O} and θ are as defined above, ω_{y} is half of the vertical field of view of device 302 (in inclusive representation), D is the grating period and λ is the wavelength of the light. When the light is polychromatic, λ is preferably the longest wavelength of the spectrum.

In embodiments in which elements 310, 312 and 314 are linear diffraction gratings, the grating vectors of all three gratings are preferably substantially parallel to each other and to the x direction. Due to the slanted configuration, light can propagate from the input grating to the output gratings even though the input and output gratings are offset with respect to each other. This is an advantage over the configuration disclosed in International Publication No. WO 2007/052265 in which the left and right output gratings have non-parallel grating vectors.

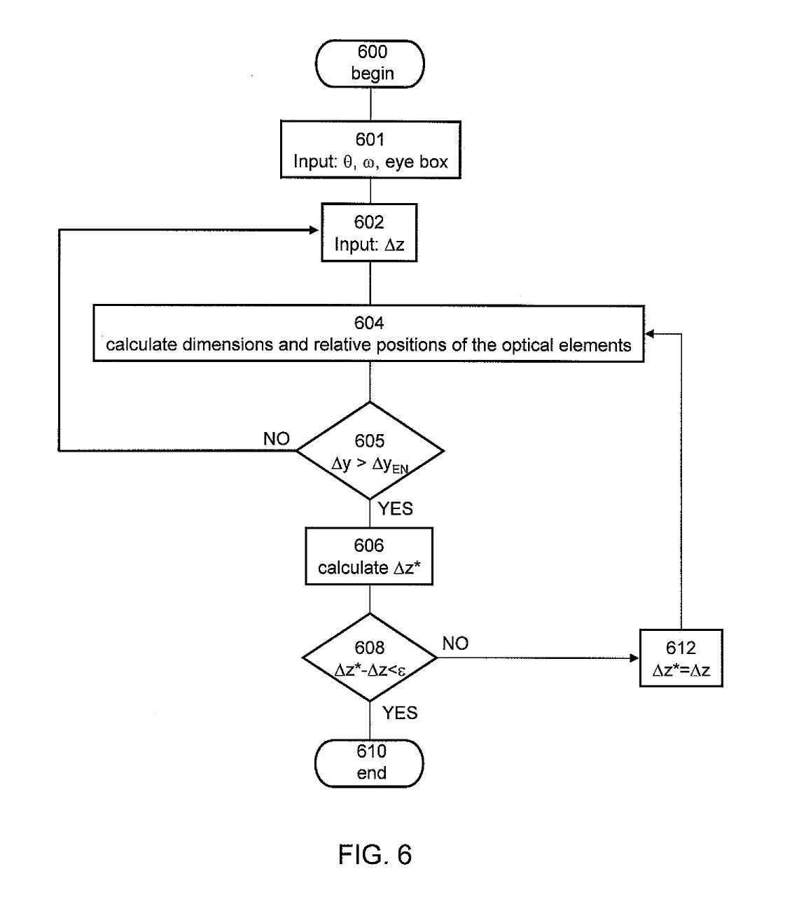

FIG. 6 is a flowchart diagram describing a method suitable for designing optical relay device 302. The method begins at 600 and continues to 601 at which a tilt angle θ of substrate 316 with respect to optical axis 308, an angular field of view 2ω_{y} and eye box dimensions are inputted. The method proceeds to 602 at which an eye relief distance Δz is inputted and. At 604 the method calculates the dimensions and relative positions of the optical elements based on the input obtained at 601 and 602. Calculation can be performed by means of optical geometry. Preferably, the method first calculates the dimensions of the output elements based on the inputted field of view and eye relief. Thereafter, the method uses the output elements' dimensions for calculating the dimension and offset value Δy′ of the input optical element.

For example, the width W_{O} of elements 312 and 314 (along the x′ direction) can be selected to be larger then a predetermined width threshold, W_{O, min}, and the length L_{O} of elements 312 and 314 (along the y′ direction) can be selected to be larger then a predetermined length threshold, L_{O, min}. In various exemplary embodiments of the invention the length and width thresholds are given by the following expressions:

W_{O}, ₘᵢₙ=2 Δz tan ωₓ

L_{O}, ₘᵢₙ=2 Δz tan ω_{y}, (EQ. 9)

where ωₓ is the horizontal field of view angle and ω_{y} is the vertical field of view angle.

The length L_{O} and width W_{O} of elements 312 and 314 can be approximated by L_{O}≈L_{O}, ₘᵢₙ+Oₚ, and W_{O}≈W_{O}, ₘᵢₙ+Oₚ, respectively, where Oₚ represents the diameter of the pupil and is typically about 3 millimeters. In various exemplary embodiments of the invention the eye-box is larger than the diameter of the pupil, so as to allow the user to relocate the eye within the eye-box while still viewing the entire virtual image. Thus, denoting the dimensions of the eye box by L_{EB} and W_{EB}, where L_{EB} is measured along the x axis and W_{EB} is measured along the y axis, the length and width of elements 312 and 314 can be calculated according to the following formula:

L_{O}=L_{O}, ₘᵢₙ+L_{EB}

W_{O}=W_{O}, ₘᵢₙ+W_{EB}, (EQ. 10)

where each of L_{EB} and W_{EB} is preferably larger than Oₚ.

A typical value for W_{EB} is, without limitation, from about 5 millimeters to about 13 millimeters, and a typical value for L_{EB} is, without limitation, is from about 4 millimeters to about 9 millimeters.

The dimensions of input optical element 310 can be selected to allow all light rays within the field of view to propagate in the substrate such as to impinge on the area of the respective output elements. In various exemplary embodiments of the invention the width W_{I} of input element 310 equals from about h sin δ to about 3 h sin δ, where h is a unit hop-length characterizing the propagation of light rays within substrate 316 and δ is given by tan δ=IPD/(2 Δy′). Typically, h equals the hop-length of the light-ray with the minimal hop-length, which is one of the outermost light-rays in the field of view. When the light has a plurality of wavelengths, h is typically the hop-length of one of the outermost light-rays which has the shortest wavelength of the spectrum.

According to some embodiments of the present invention the length L_{O} of elements 312 and 314 is shorter than the length L_{I} (along the y′ direction) of element 310. L_{I} can be calculated based on the selected shape of substrate 316. According to some embodiments of the present invention the relation between L_{I} and L_{O} is given by the following expression:

L_{I}=L_{O}+(W_{O}+IPD/2)tan γ₁−(W₁+IPD/2)tan γ₂, (EQ. 11)

where γ₁ and γ₂ are predetermined angular parameters.

Preferably, γ₁ and γ₂ relate to the propagation direction of one or more of the outermost light rays of the field of view within the substrate, as projected on a plane parallel to the substrate (the x′-y′ plane). In various exemplary embodiments of the invention γ₁ is set to the angle formed between the x′ direction and a straight line connecting the top left corner of element 310 with the top left corner of element 314 (or the straight line connecting the top right corner of element 310 with the to right corner of element 312), see, e.g., line 361 in FIG. 4, and γ₂ is set to the angle formed between the x′ direction and a straight line connecting the lower right corner of element 310 with the lower right corner of element 314 (or the straight line connecting the lower left corner of element 310 with the lower left corner of element 312), see, e.g., line 362 in FIG. 4.

Once the dimensions and relative positions of the optical elements are calculated, the method determines whether further reduction of Δz is possible. Further reduction of Δz is possible if the lowest edge 340 of the input element is above the nose line of a typical viewer. Thus, in some embodiments of the present invention the method calculates the vertical distance Δy (along the y direction) between the centers of the output elements (see line 354 in FIG. 4) and the lowest edge 340 of the input element, according to the expression Δy=(0.5L_{O}−Δy′)cos θ. The method then retrieves, e.g., from a lookup table, the vertical distance Δy_{EN} (see FIG. 5B) between the line connecting the pupils and the nose of a typical viewer (for given values of the inputs Δz and θ). At decision 605 the method determines if Δy>Δy_{EN}.

If Δy>Δy_{EN}, the method determines that it is possible to further reduce Δz and proceeds to 606 at which a new, lower, eye relief distance is calculated based on Δy, Δy_{EN} and calculated dimensions of the input and output optical elements. The calculated value of the eye relief reduction is denoted Δz*. If Δy<Δy_{EN}, the method loops back to 602 at which a larger value of Δz is inputted.

The iteration can be repeated until a predetermined stop criterion is met. For example, from 606 the method can proceed to decision 608 at which the method determines whether or not the difference Δz*−Δz is below a predetermined threshold ε. If Δz*−Δz<ε, the method proceeds to 610 where it ends; if not, the method continues to 612 at which Δz is assigned with the calculated value Δz*, and loops back to 604 for another iteration. The method can also end if Δy=Δy_{EN}.

A preferred value for the threshold ε is less than 2 mm, more preferably less than 1 mm. A typical input value for Δz is, without limitation, from about 15 millimeters to about 35 millimeters.

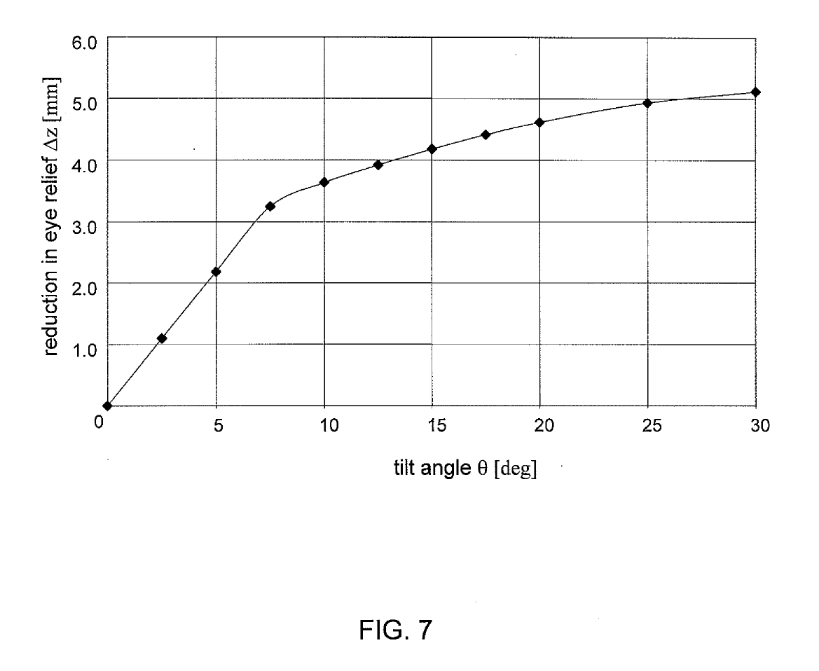

FIG. 7 presents result of iterations performed according to some embodiments of the present invention for a vertical field of view ω_{y} of 15.6° and IPD of 63 mm. Shown in FIG. 7 is the reduction in Δz as a function of θ. As shown Δz reduction stabilizes at about 5 mm for θ of about 25°.

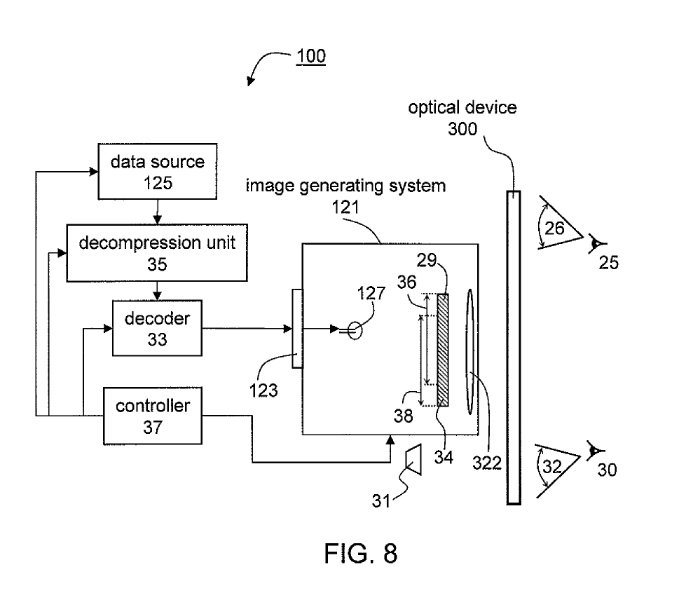

FIG. 8 is a schematic illustration of a system 100 for generating and transmitting an image, according to various exemplary embodiments of the present invention. System 100 comprises an optical device (e.g., device 300) for transmitting an image 34 into left eye 25 and right eye 30 of the user, and an image generating system 121 for providing optical relay device 300 with collimated light constituting the image.

In various exemplary embodiments of the invention the light is polychromatic light constituting a multicolor image. Ideally, a multicolor image is a spectrum as a function of wavelength, measured at a plurality of image elements. This ideal input, however, is rarely attainable in practical systems. Therefore, the present embodiment also addresses other forms of imagery information. A large percentage of the visible spectrum (color gamut) can be represented by mixing red, green, and blue colored light in various proportions, while different intensities provide different saturation levels. Sometimes, other colors are used in addition to red, green and blue, in order to increase the color gamut. In other cases, different combinations of colored light are used in order to represent certain partial spectral ranges within the human visible spectrum.

In a different form of color imagery, a wide-spectrum light source is used, with the imagery information provided by the use of color filters. The most common such system is using white light source with cyan, magenta and yellow filters, including a complimentary black filter. The use of these filters could provide representation of spectral range or color gamut similar to the one that uses red, green and blue light sources, while saturation levels are attained through the use of different optical absorptive thickness for these filters, providing the well known “grey levels.”

Thus, the multicolored image can be displayed by three or more channels, such as, but not limited to, Red-Green-Blue (RGB) or Cyan-Magenta-Yellow-Black (CMYK) channels. RGB channels are typically used with light emitting display (e.g., CRT or OLED) or spatial light modulator systems (e.g., Digital Light Processing™ (DLP™) or LCD or LCoS display illuminated with RGB light sources such as LEDs or laser diodes). CMYK images are typically used for passive display systems (e.g., print). Other forms are also contemplated within the scope of the present invention.

When the multicolor image is formed from a discrete number of colors (e.g., an RGB display), system 121 provides a plurality of quazi-monochromatic spectra. For example, a multicolor image can be provided by an OLED array having red, green and blue organic diodes (or white diodes used with red, green and blue filters) which are viewed by the eye as continuous spectrum of colors due to many different combinations of relative proportions of intensities between the colors of light emitted thereby.

Image generating system 121 can be either analog or digital. An analog image generating system typically comprises a light source 127, at least one image carrier 29 and a collimating system 322. Collimating system 322 serves for projection the image to infinity, if it is not already projected to infinity prior to impinging on substrate 14. In the schematic illustration of FIG. 8, collimating system 322 is illustrated as integrated within system 121, however, this need not necessarily be the case since, for some applications, it may be desired to have collimating system 322 as a separate element. Thus, system 121 can be formed of two or more separate units. For example, one unit can comprise the light source and the image carrier, and the other unit can comprise the collimating system. Collimating system 322 is positioned on the light path between the image carrier and the input element of device 302.

Any collimating element known in the art may be used as collimating system 322, for example a positive lens (spherical or aspherical), an arrangement of lenses, a diffractive optical element and the like.

In case of a positive lens, a line connecting the centers of curvature of each surface, defines the optical axis. The bundle of rays passing through the lens cluster about this axis and may be well imaged by the lens, for example, if the source of the light is located as the focal plane of the lens, the image constituted by the light beam is projected to infinity.

Representative examples for light source 127 include, without limitation, a lamp (incandescent or fluorescent), one or more LEDs or OLEDs, laser diodes, and the like. Representative examples for image carrier 29 include, without limitation, a miniature slide, a reflective or transparent microfilm and a hologram. The light source can be positioned either in front of the image carrier (to allow reflection of light therefrom) or behind the image carrier (to allow transmission of light therethrough). Optionally and preferably, system 121 comprises a miniature CRT. Miniature CRTs are known in the art and are commercially available, for example, from Kaiser Electronics, a Rockwell Collins business, of San Jose, Calif.

A digital image generating system typically comprises at least one display and a collimating system. The use of certain displays may require, in addition, the use of a light source. In the embodiments in which system 121 is formed of two or more separate units, one unit can comprise the display and light source, and the other unit can comprise the collimating system.

Light sources suitable for a digital image generating system include, without limitation, a lamp (incandescent or fluorescent), one or more LEDs (e.g., red, green and blue LEDs) or OLEDs, laser diodes. and the like. Suitable displays include, without limitation, rear-illuminated transmissive or front-illuminated reflective LCD/LCoS, OLED arrays, Digital Light Processing™ (DLP™) units, miniature plasma display, and the like. A light emitting display, such as OLED or miniature plasma display, may not require the use of additional light source for illumination. Transparent miniature LCDs are commercially available, for example, from Kopin Corporation, Iljin, Mass. Reflective LCoS displays are commercially available, for example, from DisplayTech, Aurora. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

According to some embodiments of the present invention system 100 comprises a data source 125 which can communicate with system 121 via a data source interface 123. Any type of communication can be established between interface 123 and data source 125, including, without limitation, wired communication, wireless communication, optical communication or any combination thereof. Interface 123 is preferably configured to receive a stream of imagery data (e.g., video, graphics, etc.) from data source 125 and to input the data into system 121. Many types or data sources are contemplated. According to a preferred embodiment of the present invention data source 125 is a communication device, such as, but not limited to, a cellular telephone, a personal digital assistant and a portable computer (laptop). Additional examples for data source 125 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 125 may generates also audio information. The audio information can be received by interface 123 and provided to the user, using an audio unit 31 (speaker, one or more earphones, etc.).

According to various exemplary embodiments of the present invention, data source 125 provides the stream of data in an encoded and/or compressed form. In these embodiments, system 100 further comprises a decoder 33 and/or a decompression unit 35 for decoding and/or decompressing the stream of data to a format which can be recognized by system 121. Decoder 33 and decompression unit 35 can be supplied as two separate units or an integrated unit as desired.

System 100 preferably comprises a controller 37 for controlling the functionality of system 121 and, optionally and preferably, the information transfer between data source 125 and system 121. Controller 37 can control any of the display characteristics of system 121, such as, but not limited to, brightness, hue, contrast, pixel resolution and the like. Additionally, controller 37 can transmit signals to data source 125 for controlling its operation. More specifically, controller 37 can activate, deactivate and select the operation mode of data source 125. For example, when data source 125 is a television apparatus or being in communication with a broadcasting station, controller 37 can select the displayed channel; when data source 125 is a DVD or MP4 player, controller 37 can select the track from which the stream of data is read; when audio information is transmitted, controller 37 can control the volume of audio unit 31 and/or data source 125.

Reference is now made to FIGS. 9A-C which illustrate system 100 in an embodiment in which device 300 is worn as spectacles. In this embodiment system 100 comprises a spectacles body 112, having a housing 114, for holding image generating system 21 (not shown, see FIG. 8); a bridge 122 having a pair of nose clips 118, adapted to engage the user's nose; and rearward extending arms 116 adapted to engage the user's ears. Optical relay device 302 is preferably mounted between housing 114 and bridge 122. According to some embodiments of the present invention system 100 comprises a one or more earphones 119 which can be supplied as separate units or be integrated with arms 116.

Interface 123 (not explicitly shown in FIGS. 9A-C) can be located in housing 114 or any other part of body 112. In embodiments in which decoder 33 is employed, decoder 33 can be mounted on body 112 or supplied as a separate unit as desired. Communication between data source 25 and interface 123 can be, as stated, wireless, in which case no physical connection is required between wearable device 110 and data source 25. In embodiments in which the communication is not wireless, suitable communication wires and/or optical fibers 120 are used to connect interface 123 with data source 25 and the other components of system 100.

System 100 can also be used in combination with a vision correction device 130, for example, one or more corrective lenses for correcting, e.g., short-sightedness (myopia). In this embodiment, the vision correction device is preferably positioned between the eyes and device 302.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

In various exemplary embodiments of the invention substrate 316 is made of a light transmissive material characterized by low birefringence.

Optical birefringence, also known as double refraction, is an optical phenomenon which is associated with optically anisotropic materials, whereby the material exhibits a different refraction index for each of two polarization directions defined by the material. An optically anisotropic material rotates the polarization plane of the light as the light propagates therethrough.

Since optically anisotropic materials exhibits different refraction indices in different directions, their refraction index is a vector quantity, n, commonly written as n=(nₒ, nₑ), where the nₒ is referred to as the ordinary refraction index and nₑ is referred to as the extraordinary refraction index. Also known are more complicated materials for which the refraction index is a tensor quantity.

The level of anisotropy of the material is quantified by a quantity called birefringence. The birefringence can be expressed as an optical path difference, when the light propagates through a unit length of the material. The optical path Λ of the light along a geometrical distance x is defined as Λ=ct, where c is speed of light in the vacuum and t is the propagation time of a single component of the light along the distance x.

A commonly used unit for birefringence is nanometer per centimeter. For example, suppose that when the light propagates along x centimeters of the material in one direction its optical distance is Λ₁ nanometers, and when the light propagates along x centimeters of the material in another direction its optical distance is Λ₂ nanometers. The birefringence of the material is defined as the ratio (Λ₁−Λ₂)/x. The birefringence can also be expressed as a dimensionless quantity, which is commonly defined as the difference between the ordinary and extraordinary refraction indices: Δn=nₒ−nₑ. From the above definition of the optical path and the refraction index it follows that the dimensional and dimensionless definitions of the birefringence are equivalent.

Unless otherwise stated, the term “birefringence” refers herein to the dimensionless definition of the birefringence, Δn=nₑ−nₒ. One of ordinary skills in the art, provided with the details described herein would know how to obtain the dimensional birefringence from its dimensionless equivalent.

The birefringence of the light transmissive material of the present embodiments preferably satisfies the inequality |Δn|<ε, where ε is lower than the birefringence of polycarbonate. In various exemplary embodiments of the invention ε equals 0.0005, more preferably 0.0004, more preferably 0.0003, even more preferably 0.0002.

In various exemplary embodiments of the invention the light transmissive material comprises a polymer or a copolymer. Polymers or copolymers suitable for the present embodiments are characterized by isotropic optical activity and at least one, more preferably at least two additional characteristics selected from: high transmission efficiency, good molding ability, low moisture permeability, chemical resistance and dimensional stability.

Exemplary light transmissive materials suitable for the present embodiments include, without limitation, cycloolefin polymers, cycloolefin copolymers and other polycyclic polymers from cycloolefinic monomers such as norbornene, hydrocarbyl and/or halogen substituted norbornene-type monomers, polymers and/or copolymers containing N-halogenated phenyl maleimides, N-halogenated phenyl bismaleimides, halogenated acrylates, halogenated styrenes, halogenated vinyl ethers, halogenated olefins, halogenated vinyl isocyanates, halogenated N-vinyl amides, halogenated allyls, halogenated propenyl ethers, halogenated methacrylates, halogenated maleates, halogenated itaconates, halogenated crotonates, and other amorphous transparent plastics.

In various exemplary embodiments of the invention the light transmissive material comprises a cycloolefin polymer or a cycloolefin copolymer, such as those commercially available from suppliers such as Zeon, Japan, under the trade-names Zeonex™ and Zeonor™, from Ticona, a business of Celanese Corporation, USA, under the trade-name Topas™, and from Mitsui Chemicals Group under the trade name APEL™. Although both cycloolefin polymer and cycloolefin copolymer are preferred over the above light transmissive materials, cycloolefin polymer is more favored over cycloolefin copolymer, because the temperature window for fabricating a substrate which comprises a cycloolefin polymer is wider.

In a preferred embodiment in which the surfaces of substrate 316 are substantially parallel, the optical elements can be designed, for a given spectrum, solely based on the value of the field of view and the value of the shortest wavelength λ_{B} of the spectrum. For example, when the optical elements are linear gratings, the period, D, of the gratings can be selected based on the field of view and λ_{B}, irrespectively of the optical properties of the substrate or any wavelength longer than λ_{B}.

According to a preferred embodiment of the present invention D is selected such that the ratio λ_{B}/D is from about 1 to about 2. A preferred expression for D is given by the following equation:

D=λ_{B}/[n_{A}(1−sin ω)], (EQ. 12)

where n_{A} is the index of refraction of the medium outside the light transmissive substrate and ω is the so called diagonal field of view, as defined, for example, in International Patent Publication No. WO2007/052265 supra.

It is appreciated that D, as given by Equation 12, is a maximal grating period. Hence, in order to accomplish total internal reflection D can also be smaller than λ_{B}/[n_{A}(1−sin ω)].

The substrate can be selected such as to allow light having any wavelength within the spectrum and any striking angle within the field of view to propagate in the substrate via total internal reflection.

According to some embodiments of the present invention the refraction index of the substrate is larger than λ_{R}/D+n_{A} sin(ω), where λ_{R} is the longest wavelength of the spectrum. Preferably, the refraction index, n_{S}, of substrate 14 satisfies the following equation:

n_{S}≧[λ_{R}/D+n_{A} sin(ω)]/sin(α_{D}^{MAX}). (EQ. 13)

where α_{D}^{MAX} is the largest diffraction angle. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

The thickness, t, of the substrate can be from about 0.1 mm to about 5 mm, more preferably from about 1 mm to about 3 mm, even more preferably from about 1 to about 2.5 mm. For multicolor use, t is preferably selected to allow simultaneous propagation of plurality of wavelengths, e.g., t>10 λ_{R}. The shortest wavelength, λ_{B}, generally corresponds to a blue light having a typical wavelength of between about 400 to about 500 nm and the longest wavelength, λ_{R}, generally corresponds to a red light having a typical wavelength of between about 600 to about 700 nm.

According to some embodiments of the present invention a ratio between the wavelength, λ, of the light and the period D is larger than or equal a unity:

λ/D≧1. (EQ. 14)

This embodiment can be used to provide an optical device operating according to the principle in which there is no mixing between light rays of the non-overlapping parts of the field of view.

According to some embodiments of the present invention the ratio λ/D is smaller than the refraction index, nₛ, of the substrate. More specifically, D and nₛ can be selected to comply with the following inequality:

D>λ/(nₛ p), (EQ. 15)

where p is a predetermined parameter which is smaller than 1.

The value of p can be selected so as to ensure operation of the device according to the principle in which some mixing is allowed between light rays of the non-overlapping parts of the field of view. This can be done for example, by setting p=sin(α_{D}^{MAX}).

According to some embodiments of the present invention, for a polychromatic spectrum the gratings period are selected to comply with Equation 14, for the shortest wavelength, and with Equation 15, for the longest wavelength. Specifically:

λ_{R}/(nₛ p)≦D≦λ_{B}. (EQ. 16)

Note that it follows from Equation 14 that the index of refraction of the substrate should satisfy, under these conditions, nₛ p≧λ_{R}/λ_{B}.

The grating period can also be smaller than the sum λ_{B}+λ_{R}, for example:

$$D = \frac{{λ}_{B} + {λ}_{R}}{{n}_{S} sin ( {α}_{D}^{MAX} ) + {n}_{A}} . \qquad ( EQ . 17 )$$

As used herein, the term “about” or “approximately” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An optical device, comprising:
a planar substrate having a lower edge and an upper edge and being formed with an input optical element for receiving and redirecting light for propagation of said light within said substrate, and a left and a right output optical elements for receiving light propagating within said substrate and coupling said light out of said substrate; and
a mounting member configured for mounting said substrate in front of a face of a viewer having eyes engaging an eye plane in a manner such that:
said substrate is slanted with respect to said eye plane and the distance between said eye plane and said lower edge is shorter than the distance between said eye plane and said upper edge;
said left and said right output optical elements respectively provide said light to a left eye and a right eye of said viewer.

2.-3. (canceled)

4. A system for generating and transmitting an image, comprising the optical device of claim 1, and an image generating system for providing the optical device with collimated light constituting the image.

5. A system for generating and transmitting an image, comprising:
an image generating system for generating collimated light constituting the image and being characterized by a principal direction of propagation; and
an optical device having a planar substrate formed with:
an input optical element for receiving and redirecting said collimated light for propagation of said light within said substrate, and a left and a right output optical elements for receiving light propagating within said substrate and coupling said light out of said substrate;
wherein said left output optical element is laterally displaced from said right output optical element, and wherein said substrate is slanted at an acute tilt angle with respect to said principal direction.

6. The system of claim 5, wherein the center of said input optical element is offset with respect to a straight line connecting the center of said left output optical element and the center of said right output optical element.

7. A method of viewing an image using the device of claim 1, comprising transmitting a light beam constituting the image to said input optical element and viewing the image through said output optical elements.

8. A method of viewing an image, comprising,
placing in front of the eyes an optical device having a planar substrate having a lower edge and an upper edge and being formed with an input optical element for receiving and redirecting light for propagation of said light within said substrate, and a left and a right output optical element for receiving light propagating within said substrate and coupling said light out of said substrate; and
transmitting a light beam constituting the image to said input optical element, thereby viewing the image;
wherein said placing is such that:
said substrate and is slanted with respect to an eye plane engaged by the eyes and the distance between said substrate and said eye plane is shorter at said lower edge than at said upper edge;
said left and said right output optical elements respectively provide said light to the left eye and the right eye.

9. A method of designing an optical relay device having a planar substrate formed with an input optical element and a left and a right output optical elements, the method comprising:
(a) inputting a tilt angle of said substrate with respect to a principal direction, an angular field of view, eye box dimensions and an eye relief distance;
(b) calculating dimensions and relative positions of said optical elements based on said input;
(c) calculating a calculated eye relief distance; and
(d) iteratively repeating (b)-(c) based on a comparison between said calculated eye relief distance and said inputted eye relief distance.

10. The device of claim 1, wherein a lowest edge of said input optical element is offset with respect to a straight line connecting the lowest edges of said output optical elements.

11. The device of claim 10, wherein said offset is optimized to ensure light propagation from a corner of said input optical element to a closest corner of said output optical elements.

12. The device of claim 11, wherein said offset is approximately (IPD−W_{I}−W_{O})tg φ/2, wherein IPD is the distance between centers of said output optical elements, W_{I} is a width of said input optical element, W_{O} is a width of said output optical elements, and φ is an angle of said light propagation between said closest corners relative to a direction defined by said centers of said output optical elements.

13. The device of claim 1, wherein said input and said output optical elements are linear diffraction gratings.

14. The device of claim 13, wherein a lowest edge of said input optical element is offset with respect to a straight line connecting lowest edges of said output optical elements.

15. The device of claim 14, wherein said offset is approximately (IPD−W_{I}−W_{O})D sin(θ−ω)/(2λ), wherein IPD is the distance between said centers of said output optical elements, W_{I} is a width of said input optical element, W_{O} is a width of said output optical elements, D is the grating period, θ is a tilt angle, ω is half a vertical field of view of the device and λ is a wavelength of said light, and wherein said tilt angle is measured between a normal to said substrate and a straight line connecting one of said eyes and a center of a respective output element.

16. The device of claim 14, wherein said light is polychromatic light having a spectrum of wavelengths and wherein said offset is approximately (IPD−W_{I}−W_{O})D sin(θ−ω)/(2λ_{R}), wherein IPD is the distance between said centers of said output optical elements, W_{I} is a width of said input optical element, W_{O} is a width of said output optical elements, D is the grating period, θ is a tilt angle, ω is half a vertical field of view of the device and λ_{R} is a longest wavelength of said spectrum, and wherein said tilt angle is measured between a normal to said substrate and a straight line connecting one of said eyes and a center of a respective output element.

17. The device of claim 1, wherein said substrate comprises a recess for receiving a nose of said viewer.

18. The device of claim 17, wherein a tilt angle is selected so as to reduce an eye relief distance by at least 10%, and wherein said tilt angle is measured between a normal to said substrate and a straight line connecting one of said eyes and a center of a respective output element.

19. The device of claim 1, wherein said device is characterized by a horizontal field of view of at least 15 degrees, and is capable of providing said field of view to a viewer having any interpupillary distance from about 40 millimeters to about 80 millimeters.

20. The device of claim 14, wherein said offset is optimized to ensure light propagation between from a corner of said input optical element to a closest corner of said output optical elements.

21. The device of claim 1, wherein the center of said input optical element is offset with respect to a straight line connecting the center of said left output optical element and the center of said right output optical element.

22. The device of claim 21, wherein said offset is optimized to ensure light propagation between from a corner of said input optical element to a closest corner of said output optical elements.
